(19) United States
(12) Patent Application Publication
(10) Pub. No.: US 2026/0170801 A1
(43) Pub. Date: Jun. 18, 2026

(54) Device and Method for Classifying an Object

(71) Applicant: MOTOROLA SOLUTIONS, INC., CHICAGO, IL (US)

(72) Inventors: FILIP NORYS, CHRZANOW (PL); PIOTR WILK, KRAKOW (PL)

(21) Appl. No.: 18/978,275

(22) Filed: Dec. 12, 2024

(51) Int. Cl. G06V 10/764; G01N 25/18; G06V 10/141; G06V 10/147; G06V 10/40; G06V 20/52

(52) U.S. Cl. CPC G06V 10/764; G01N 25/18; G06V 10/147; G06V 10/40; G06V 20/52; G06V 10/141

(57) ABSTRACT

A process for classifying an object. In operation, an electronic computing device detects an object and in response determines a set of candidate object classification for the object. The device selects, for each of the candidate object classifications included in the set, a material that differentiates a reference object used to define the candidate object classification from other reference objects used to define other candidate object classifications. The device controls an energy emitting device to emit a focused beam of energy in a direction toward the object, and responsively capture changes in thermal characteristics corresponding to the object. The device classifies the detected object under a particular one of the candidate object classifications when the changes in the thermal characteristics captured corresponding to the object correlate with the changes expected in thermal characteristics of the material selected corresponding to the particular one of the candidate object classifications.

### BACKGROUND

The ability to accurately identify and classify objects is a critical requirement in a variety of applications, including security operations, border surveillance, wildlife research, and unmanned aerial vehicle (UAV) management. Traditional systems of remote object identification are limited by their capacity to discern objects with similar visual profiles, leading to difficulties in achieving high levels of accuracy in classifying objects.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of an electronic computing device shown in FIG. 1 in accordance with some embodiments.

FIG. 3 illustrates a flowchart of a process for classifying an object in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Classifying objects with similar appearances is particularly challenging because conventional systems often rely on broad physical characteristics that can be shared across different categories of objects. For example, the task of distinguishing between a bird and a drone may pose a significant challenge. Birds and drones may have comparable size and flight patterns when observed from a distance, making it difficult for visual or radar-based systems to accurately differentiate between the two. The ambiguity can lead to misclassification, which, in a security context, could either trigger false alarms or result in a failure to respond to an actual threat. To address the above limitations, there is a need for a technological solution that provides for classifying objects with similar visual profiles.

One embodiment provides a method of classifying an object. The method comprises detecting, at an electronic computing device, an object; determining, at the electronic computing device, a set of candidate object classifications for the object; selecting, at the electronic computing device, for each of the candidate object classifications included in the set, a material that differentiates a reference object used to define the candidate object classification from other reference objects used to define other candidate object classifications included in the set; controlling, at the electronic computing device, an energy emitting device to emit a focused beam of energy in a direction toward the object, and responsively capturing changes in thermal characteristics corresponding to the object; comparing, at the electronic computing device, the changes in thermal characteristics captured corresponding to the detected object with changes expected in thermal characteristics of the material selected corresponding to each of the candidate object classifications included in the set; and classifying, at the electronic computing device, the detected object under a particular one of the candidate object classifications included in the set when the changes in the thermal characteristics captured corresponding to the object correlate with the changes expected in thermal characteristics of the material selected corresponding to the particular one of the candidate object classifications.

Another embodiment provides an electronic computing device, comprising: a communications interface; and an electronic processor communicatively coupled to the communications interface. The electronic processor is configured to: detect an object; determine a set of candidate object classifications for the object; select, for each of the candidate object classifications included in the set, a material that differentiates a reference object used to define the candidate object classification from other reference objects used to define other candidate object classifications included in the set; control an energy emitting device to emit a focused beam of energy in a direction toward the object, and responsively capturing changes in thermal characteristics corresponding to the object; compare the changes in thermal characteristics captured corresponding to the detected object with changes expected in thermal characteristics of the material selected corresponding to each of the the candidate object classifications included in the set; and classify the detected object under a particular one of the candidate object classifications included in the set when the changes in the thermal characteristics captured corresponding to the object correlate with the changes expected in thermal characteristics of the material selected corresponding to the particular one of the candidate object classifications.

Each of the above-mentioned embodiments will be discussed in more detail below, starting with example system and device architectures of the system in which the embodiments may be practiced, followed by an illustration of processing blocks for achieving an improved technical method and device for classifying an object. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

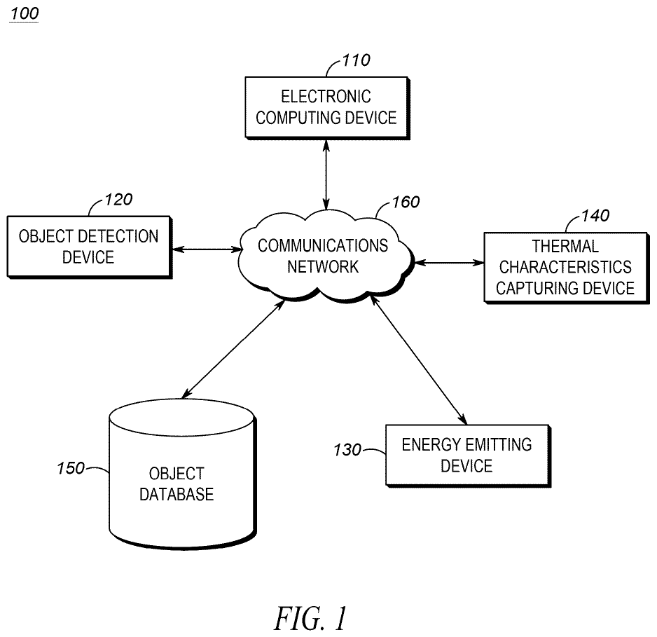

Referring now to the drawings, and in particular FIG. 1, a system 100 is shown including an electronic computing device 110, an object detection device 120, an energy emitting device 130, a thermal characteristics capturing device 140, an object database 150, and a communications network 160. In accordance with embodiments, the electronic computing device 110 is any computing device that is configured to execute a process for classifying an object. The term “object” encompasses any discrete entity that can be identified within an environment by the object detection device 120. This definition is inclusive of persons, whether stationary or in motion, as well as a wide assortment of inanimate items ranging from vehicles to weapons, and naturally occurring elements such as rocks or trees. Additionally, the term extends to cover various types of flying objects, including but not limited to, unmanned aerial vehicles (UAVs), commonly known as drones, as well as birds and other airborne wildlife. The term “object” is meant to be broad and comprehensive, encapsulating any tangible or physical item that can be sensed or observed within the operational range of the object detection device 120.

The object detection device 120 may include any device designed to recognize the presence of an object with a certain range or field of view, regardless of the environmental conditions or the state of motion of the object. This includes devices such as visible spectrum cameras, which capture visual data in the form of images or videos, and a wide array of other instrumentalities that may utilize different modalities to detect objects. Examples of such modalities include, but are not limited to, radar systems that use radio waves to determine the range, angle, or velocity of objects; infrared sensors that detect heat signatures; sonar systems that employ sound propagation to detect objects underwater; and LiDAR (Light Detection and Ranging) technology that uses light in the form of a pulsed laser to measure distances. These devices may operate individually or in concert, often integrated into other systems, to reliably detect objects at various distances and provide information indicating detection of an object including the position or location of the detected object to the electronic computing device 110.

The energy emitting device 130 is any device capable of emitting a focused beam of energy towards an object to induce an alteration in the object's material thermal properties. The focused beam of energy may take the form of light, sound, or electromagnetic waves. In accordance with some embodiments, the energy emitting device 130 is configured to target objects from varying distances and can be calibrated to emit energy at specific frequencies and intensities for a specified duration of time. In one embodiment, the energy emitting device 130 may include a laser pointer that emits a narrow, focused beam of light to cause a localized increase in temperature in portions of the object. In another embodiment, the energy emitting device 130 may include an ultrasonic transducer that produces high-frequency sound waves. When these waves are targeted at an object, they can lead to thermal effects due to absorption and friction in molecules of the object. In another embodiment, the energy emitting device may include a microwave emitter that generates and emits electromagnetic waves in the microwave spectrum that is capable of penetrating various materials in the objects and causing molecules in the object to vibrate, subsequently raising the temperature in the material. What should be understood is that each of these devices leverages the principle of energy transmission through various media to interact with objects, causing localized thermal changes in the object.

The thermal characteristics capturing device 140 includes any device that can detect, monitor, capture, and record variations in the thermal properties of an object. The thermal properties may include, but are not limited to, changes in temperature distribution, heating and cooling rates, or thermal conductivity. In accordance with some embodiments, the thermal characteristics capturing device 140 is configured to be activated to capture changes in thermal characteristics of an object in response to an object being subjected to a focused beam of energy, such as light, sound, or electromagnetic waves emitted by the energy emitting device 130, which can alter the thermal state of the object's materials. The thermal conductivity can be observed from an object by analyzing the rate at which the heat is dissipated from the object. Materials with high thermal conductivity will spread the heat quickly, resulting in a broader and faster temperature change, whereas low-conductivity materials will retain the heat locally. The thermal characteristics capturing device 140 may include one or more infrared (IR) thermal cameras that can detect infrared energy (heat) emitted from the surface of the objects and convert it into an electrical signal, which is then processed to produce a sequence of multiple frames of images. The sequence of images can capture both the heating and cooling patterns of the object over time. In accordance with some embodiments, the thermal characteristics capturing device may include long-range sensors such as long-wave infrared cameras to capture and record variations in the thermal properties of an object from a distance. The long-wave infrared camera operates in the long-wave infrared range of the infrared spectrum and can detect the heat emitted by an object without being in direct contact with the object. The camera interprets the infrared radiation as temperature values and generates a sequence of images that visually represents the heating and cooling patterns of the object over time. What should be understood is that the thermal characteristics capturing device 140 includes any device that operates on principles that allow for the detection of thermal energy and the transformation of the energy into data that can be quantized and analyzed for purposes of object classification.

The object database 150 is implemented using any type of storage device, storage server, storage area of network, redundant array of independent discs, cloud storage device, or any type of local or network-accessible storage device configured to store object information for access by the electronic computing device 110. In some embodiments, the object database 150 is a commercial cloud-based storage device. In some embodiments, the object database 150 is housed on suitable on-premises database servers. The object database 150 stores information pertaining to a list of reference objects, each associated with a known object classification. The reference object includes any “object” with a known or pre-determined classification. The classification may be based on characteristics including, but not limited to, object's size, type, material, intent, capability, structure, origin, function, mobility. In accordance with embodiments, the object database 150 further includes information about the various materials that constitute each reference object. The material may range from common substances to unique compounds that are indicative of certain object types. In accordance with some embodiments, the object database 150 identifies, for each reference object classified under a known classification, at least one unique material that differentiates the reference object from other reference objects classified under other classifications. The object database 150 may also additionally identify pre-determined thermal properties (e.g., thermal conductivity coefficient) associated with different materials that constitute the reference object. The pre-determined thermal properties associated with each material can be stored in the object database 150 in any suitable format and structure. As an example, the object database 150 may identify thermal conductivity coefficient for aluminum material as 235 watts per meter-Kelvin (W/m-K). As another example, the object database 150 may indicate thermal conductivity for feathers as 0.025 W/m-K.

For example, the object database 150 may contain entries such as: (i) drones, classified under unmanned aerial vehicles, with information noting that they are often constructed from lightweight materials like aluminum, carbon fiber composites or polycarbonate plastics, each with distinct thermal properties; (ii) birds, classified into the category of wildlife, with information noting the organic materials such as feathers, bones, and keratin, which have specific thermal responses that differ from manufactured materials included in objects classified under unmanned aerial vehicles, (iii) vehicles, classified by type (e.g., passenger, car, truck, military vehicle), with material data including steel, aluminum alloys, rubber, and glass, with their distinct thermal properties, and (iv) buildings, classified, for example, on their use (e.g., residential, commercial, industrial) and structured materials such as concrete, steel, glass, or wood, with their distinct thermal properties. The entries noted above as being included in the object database 150 are for illustrative purposes only. The object database 150 can include any number of entries for any number of reference objects that are classified under any number of known classifications. The object database 150 is communicatively coupled with the electronic computing device 110, for example, via the communications network 160, to allow the electronic computing device 110 to communicate with and retrieve data from the object database 150.

The communications network 160 may include wireless and/or wired connections. For example, the communications network 160 may be implemented using a wide area network, such as the Internet, a local area network, such as a Wi-Fi network, and personal area or near-field networks, for example a Bluetooth™ network. Portions of the communications network may include a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof.

Although FIG. 1 shows only one electronic computing device 110, one object detection device 120, one energy emitting device 130, one thermal characteristics capturing device 140, one object database 150, and one communications network 160, the system 100 may include any number of electronic computing devices 110, object detection devices 120, energy emitting devices 130, thermal characteristics capturing devices 140, object databases 150, and communications networks 160 for classifying any number of objects detected in any environment.

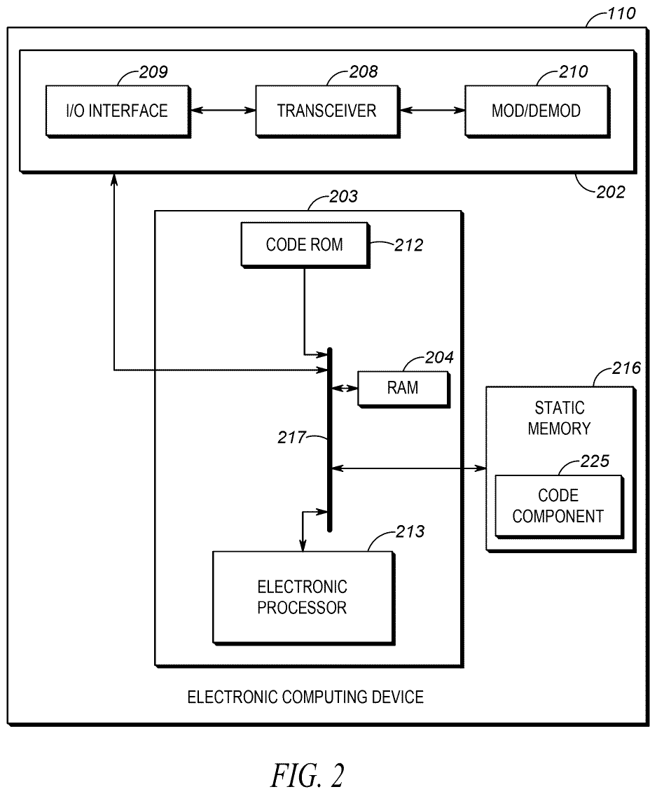

FIG. 2 is an example functional block diagram of an electronic computing device 110 operating within the system 100 in accordance with some embodiments. The electronic computing device 110 may be embodied in computing devices not illustrated in FIG. 1, and/or may be a distributed computing device across two or more of the foregoing (or multiple of a same type of one of the foregoing) and linked via a wired and/or wireless communication link(s). In one embodiment, one or more functions of the electronic computing device 110 can be implemented within one or more of the object detection device 120, energy emitting device 130, or thermal characteristics capturing device 140 shown in FIG. 1. While FIG. 2 represents an electronic computing device 110 described above with respect to FIG. 1, the electronic computing device 110 may include fewer or additional components in configurations different from that illustrated in FIG. 2.

As shown in FIG. 2, the electronic computing device 110 includes a communications interface 202 coupled to a common data and address bus 217 of a processing unit 203. The communications interface 202 sends and receives data to and from other devices in the system 100. The communications interface 202 may include one or more wired and/or wireless input/output (I/O) interfaces 209 that are configurable to communicate with other devices (e.g., object detection device 120, energy emitting device 130, thermal characteristics capturing device 140, or object database 150) in the system 100. For example, the communications interface 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications interface 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The processing unit 203 may include an encoder/decoder with a code Read Only Memory (ROM) 212 coupled to the common data and address bus 217 for storing data for initializing system components. The processing unit 203 may further include an electronic processor 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications interface 202.

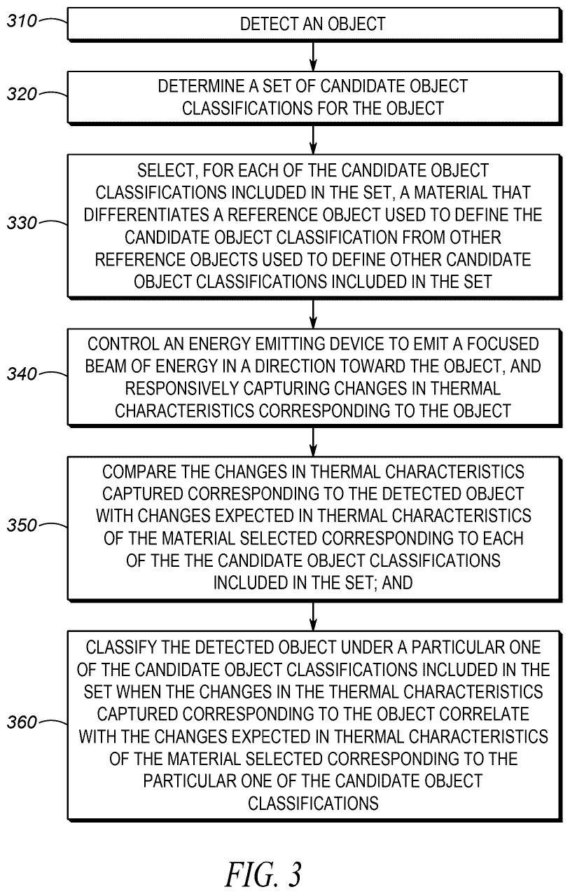

Static memory 216 may store operating code 225 for the electronic processor 213 that, when executed, performs one or more of the blocks set forth in FIG. 3, and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 may store information including position or location of detected objects that need to be classified. The static memory 216 may also store information regarding reference objects retrieved from the object database 150.

In accordance with some embodiments, the electronic computing device 110 may further include or otherwise is communicatively coupled to a visual and/or audio output device (not shown). For example, the visual and/or audio output device may include an electronic display and/or a speaker implemented on one or more computing devices (e.g., portable radio, dispatch console etc.,) associated with users (e.g., security officers) employed by an agency. A visual output in the form of text, image, or video may be rendered via the electronic display of the visual and/or audio output device. An audio output in the form of audio is played back via the speaker of the one or more computing devices associated with the users. The visual and/or audio output may include information indicating a particular classification under which an object has been classified. The visual and/or audio output may also include a security alert indicating security risk, if any, associated with a particular classified object.

Turning now to FIG. 3, a flowchart diagram illustrates a process 300 for classifying an object in accordance with some embodiments. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. An electronic computing device 110 shown in FIG. 1 and/or FIG. 2, and embodied as a singular computing device or distributed computing device may execute process 300 via an electronic processor 213.

The electronic computing device 110 may execute the process 300 at power-on, at some predetermined periodic time period thereafter, in response to a trigger raised locally at the electronic computing device 110 via an internal process or via an input interface or in response to a trigger from an external device (e.g., a user may use an external computing device to request the electronic computing device 110 to initiate the process 300) to which the electronic computing device 110 is communicably coupled, among other possibilities. As an example, the electronic computing device 110 is programmed to automatically trigger execution of the process 300 in response to detecting an object in a monitored area.

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well.

At block 310, the electronic computing device 110 detects an object. In accordance with some embodiments, the electronic computing device 110 may use the object detection device 120 shown in FIG. 1 to detect an object in an area being monitored by the electronic computing device 110. The object detection device 120 may use any object detection scheme known in the art. In one embodiment, the object detection device 120 includes one or more visible spectrum cameras that capture a sequence of images or video frames and analyzes them to identify variations in pixel, intensity, color, or pattern that signify the presence of an object. The object detection device 120 may apply image processing algorithms known in the art such as edge detection, background subtraction, or feature matching to the images or video frames to isolate and highlight the objects from the background. In addition to detecting the object, the object detection device 120 may determine a spatial position of a detected object relative to the position or location of the cameras. The object detection device 120 may also use machine learning algorithms, including, but not limited to convolutional neural networks (CNNs) to refine the object detection process. When the object detection device 120 detects the presence of an object, the object detection device 120 transmits an electronic signal to the electronic computing device 110 indicating the presence of the object and the spatial position of the object. In another embodiment, the electronic computing device 110 may detect the presence of an object based on an input received from a user. As an example, the electronic computing device 110 may present a video stream to the user via an electronic display. The user may use an input device (e.g., mouse or touch screen) to indicate an object (e.g., by creating a selection box around the object) appearing in the video stream. Based on the selection input, the electronic computing device 110 detects the presence of a particular object. The above examples for detecting an object are provided for illustrative purposes only and that any object detection technologies known in the art can be used by the electronic computing device 110 to detect the presence of an object.

At block 320, the electronic computing device 110 determines a set of candidate object classifications for the object. The electronic computing device 110 may use any object classification algorithm known in the art to determine a set of candidate object classifications for a detected object. In one embodiment, the electronic computing device 110 analyzes images or videos captured (e.g., by a visible spectrum camera) corresponding to a detected object and extracts distinguishing features such as edges, textures, shape, or color histograms. The distinguishing features are then compared against a library of known object classifications that are stored, for example, in the object database 150. Each known object classification may be populated with reference feature sets representative of various object categories. The electronic computing device 110 uses one or more of pattern recognition, machine learning, or deep learning algorithms to assess the similarity between the extracted features and the reference feature sets associated with each known object classification. The electronic computing device 110 then assigns one or more probable object classifications (referred herein as “candidate object classifications”) for the object based on the similarity between the extracted features and the reference feature sets associated with each of the one or more probable object classifications. For instance, if the extracted features match those typical of vehicles, the detected object may be classified as a vehicle. In accordance with some embodiments, the initial object classification process may yield multiple potential categories of classifications for a detected object. As an example, the visual similarity between birds and drones can pose a challenge for object detection and classification systems due to several overlapping characteristics in their appearance (e.g., silhouette and shape, size, color, and texture) and moving patterns (e.g., flight dynamics, altitude, and speed) when observed from a distance or through imagery. In this example, the electronic computing device 110 may determine that the characteristics of a detected object correlates with a first category of reference objects (e.g., drones) classified under a first candidate object classification (e.g., unmanned aerial vehicles) as well as a second category of objects (e.g., birds) classified under a second candidate object classification (e.g., wildlife). The electronic computing device 110 may also determine more than two candidate object classifications for an object during the initial object classification process performed at block 320.

In one embodiment, if the electronic computing device 110 determines that there is a threshold level of similarity (e.g., 90% or more) between the features extracted from a detected object and reference features sets associated with a single known object classification (persons), then the electronic computing devices 110 stops the execution of the process 300 at block 320 and instead proceeds to classify the detected object under the single known object classification. On the other hand, if the electronic computing device 110 determines that the features extracted from a detected object are similar (e.g., 45%-55%) to reference features associated with multiple known object classifications (e.g., birds and drones, or war drones and photo drones), then the electronic computing device 110 proceeds to execute the remainder of the process 300 to more accurately classify the object under a particular one of the candidate object classifications determined at block 320.

At block 330, the electronic computing device 110 selects, for each of the candidate object classifications included in the set of candidate object classifications determined at block 320, a material that differentiates a reference object used to define the candidate object classification from other reference objects used to define other candidate object classifications included in the set. The term “material” refers to any substance or combination of substances used in the composition, construction, or manufacturing of objects. Materials can be organic, as found in natural organisms like birds (e.g., feathers and bones), or inorganic and synthetic, as used in human-made objects (e.g., aluminum in drones). Moreover, material may also include unique material that is purposely introduced in a given object (e.g., a drone manufactured for non-commercial purposes such as a war drone) during the construction of the object to differentiate the given object from other objects (e.g., commercial drones such as a photo drone).

For example, assume that the electronic computing device 110 has determined that the features extracted from a detected object correlates with a first reference object (e.g., drone) classified under a first candidate object classification (e.g., unmanned aerial vehicles) as well as a second reference object (e.g., bird) classified under a second candidate object classification (e.g., wildlife). In this case, the electronic computing device 110 may retrieve object information from the object database 150 corresponding to the first reference object and the second reference object. Based on the object information retrieved from the object database 150, the electronic computing device 110 selects at least one first material that is included in the first reference object but not the second reference object and at least one second material that is included in the second reference object but not the first reference object. As an example, when the reference object is a drone, the electronic computing device 110 may identify at least one material that differentiates a drone from a bird. In this example, the electronic computing device 110 may retrieve, from the object database 150, database entries stored corresponding to the drone object to determine that drones can be differentiated from the birds on the basis that the drones are typically made of metal, specifically aluminum that is lacking in the bird. In this case, at block 330, the electronic computing device 110 may select aluminum as the material that can differentiate a first reference object such as a drone that is classified under the category of unmanned aerial vehicles from other visually similar reference objects such as birds that are classified under the category of wildlife. The electronic computing device 110 may similarly retrieve, from the object database 150, database entries stored corresponding to the bird object to determine that birds can be differentiated from the drones on the basis that the birds are composed of organic materials such as feathers, bones, and tissues. The electronic computing device 110 may select feathers as a material that can differentiate a second reference object such as a bird that is classified under the category of wildlife from other visually similar reference objects such as drones that are classified under the category of unmanned aerial vehicles.

In accordance with embodiments, the electronic computing device 110 selects a material for each of the candidate object not only based on whether the material can adequately differentiate a reference object used to define a particular candidate object classification from other reference objects used to define other candidate object classifications included in the set determined at block 320, but also based on a level of energy required to capture observable changes in thermal characteristics of the material. For example, assume the electronic computing device 110 has identified that a particular reference object (e.g., drone) defining a particular candidate object classification (e.g., unmanned aerial vehicles) is associated with a first material (e.g., aluminum) and a second material (e.g., plastic) that can both serve to adequately differentiate the particular reference object (e.g., drone) from other visually similar reference objects (e.g., birds). In this case, the electronic computing device 110 determines a level of energy required to capture observable changes in thermal characteristics of the first material (e.g., aluminum) as well as a level of energy required to observe thermal characteristics of the second material (e.g., plastic). The electronic computing device 110 may select the first material at block 330 when the level of energy required to capture observable changes in thermal characteristics of the first material is lower than the level of energy required to capture observable changes in thermal characteristics of the second material. On the other hand, the electronic computing device 110 may select the second material at block 330 when the level of energy required to capture observable changes in thermal characteristics of the second material is lower than the level of energy required to capture observable changes in thermal characteristics of the first material.

In one embodiment, the electronic computing device 110 computes a level of energy required to capture observable changes in thermal characteristics as a function of one or more parameters including, but not limited to, a type of energy used (e.g., light, sound, or electronic magnetic waves), distance between the energy emitting device 130 and the spatial position of the object, type of the selected material, type of the reference object, and type and configuration (e.g., thermal resolution) of the thermal characteristics capturing device 140 used to capture the changes in thermal characteristics. Some thermal characteristics capturing devices 140, for example, short-wave infrared camera, are very sensitive (e.g., to the range of 10 mK) to marginal temperature changes, meaning changes in thermal characteristics can be observed from an object using a very minimal amount of energy (e.g., 0.01 K) emitted toward the object from a long distance (e.g., 5 Km).

At block 340, the electronic computing device 110 controls an energy emitting device 130 to emit a focused beam of energy in a direction toward the detected object and responsively captures changes in thermal characteristics corresponding to the object. The focused beam of energy may be in the form of light, sound, or electromagnetic waves. In one embodiment, the electronic computing device 110 identifies a part (e.g., body) of the reference object (e.g., bird) in which the material (e.g., feathers) selected corresponding to the candidate object classification is located. The electronic computing device 110 then identifies an area of the detected object (e.g., based on the spatial position of the detected object) that corresponds to the part of the reference object in which the material selected at block 330 is located. The electronic computing device 110 then controls the energy emitting device 130 to direct the focused beam of energy particularly toward the identified area of the detected object. In accordance with some embodiments, the electronic computing device 110 controls the energy emitting device 130 by transmitting an electronic signal instructing the energy emitting device 130 to emit a focused beam of energy toward a particular object detected at block 310. The electronic signal may include information regarding one or more of (i) type of energy and/or specific frequencies of energy to be emitted, (ii) intensity of energy, (iii) a specific duration of time for which energy is to be emitted, (iv) particular area(s) or part(s) of the object toward which the energy is to be emitted or alternatively a particular material (i.e., material selected at block 330) associated with the object for which thermal response is to be captured, (v) spatial position or location of the object, (vi) one or more distinguishing features extracted corresponding to the object, and (vii) object's mobility status including object's movement pattern (e.g., flight path), if any. The electronic signal may also include other information that can be used by the energy emitting device 130 to induce an observable thermal response within the object. In response to receiving the electronic signal from the electronic computing device 110, the energy emitting device 130 calibrates itself to emit energy at specific frequencies and intensities toward the target object for the duration of time specified in the electronic signal. As an example, assuming a laser power of one (1) watt and considering any atmospheric losses, a powerful energy emitting device 130 such as a laser emitting 0.0243 J of energy would take approximately 0.074 seconds to heat a 1 cm³ piece of aluminum by 0.01 K.

At block 350, the electronic computing device 110 compares the changes in the thermal characteristics captured corresponding to the detected object with changes expected in thermal characteristics of the material selected (at block 330) corresponding to each of the candidate object classifications included in the set. The thermal characteristics may include, but are not limited to, temperature distribution, heating and cooling rates, or thermal conductivity. In accordance with some embodiments, the electronic computing device 110 controls the thermal characteristics capturing device 140 to capture changes in thermal characteristics of the object in response to the object being subjected to a focused beam of energy, such as light, sound, or electromagnetic waves emitted by the energy emitting device 130. In one embodiment, the electronic computing device 110 sends an electronic signal to the thermal characteristics capturing device 140 to request the thermal characteristics capturing device 140 to capture changes in thermal characteristics of the object for a predefined time duration. The electronic signal may include information indicating one or more of (i) spatial position or location of the object, (ii) particular area(s) or parts of the object toward which the energy is emitted or alternatively a particular material (i.e., material selected at block 330) associated with the object for which thermal response is to be captured, (iii) one or more distinguishing features extracted corresponding to the object, (iv) object's mobility status including object's movement pattern (e.g., flight path), if any, and (v) duration of time for capturing the changes in thermal characteristics. In response to receiving the electronic signal from the electronic computing device 110, the thermal characteristics capturing device 140 monitors the target object for the specified duration of time and captures the changes in thermal characteristics corresponding to the target object. As an example, the thermal characteristics capturing device 140 may include one or more infrared (IR) spectrum cameras (e.g., short wave infrared camera) that can be controlled by the electronic computing device 110 to detect infrared energy (heat) emitted from the surface of the objects and convert it into an electrical signal, which is then processed to produce a sequence of multiple frames of images to capture both the heating and cooling patterns of an object over time. The thermal characteristics capturing device 140 then transmits the sequence of images to the electronic computing device 110 for further analysis. The electronic computing device 110 then uses the sequence of images recorded by the thermal characteristics capturing device 140 to perform a comparison of the changes in thermal characteristics captured corresponding to the detected object with changes expected in thermal characteristics of the material selected corresponding to each of the candidate object classifications included in the set determined at block 320. In one embodiment, the electronic computing device 110 determines thermal conductivity based on the changes in thermal characteristics captured corresponding to the detected object. As an example, the electronic computing device 110 analyzes differences (e.g., in the form of pixel resolutions) between the sequence of images to determine a thermal conductivity coefficient associated with a particular region of the detected object. The particular region refers to any region of the object that potentially contains the selected material. As an example, when the reference object is a photo drone and the material selected at block 330 is plastic, then the particular region may correspond to regions with the photo drone that is assumed to contain plastic. The electronic computing device 110 then compares the thermal conductivity coefficient with a predefined thermal conductivity for a material selected corresponding to each of the candidate object classification. The predefined thermal conductivity coefficient may be stored corresponding to each material in the object database 150. As an example, the predefined thermal conductivity coefficient for aluminum material associated with a reference object such as a drone may be stored in the object database 150 as 237 W/mk-K. As another example, the predefined thermal conductivity coefficient for feather material associated with a reference object such as a bird may be stored in the object database 150 as 0.025 W/m-K. As a further example, the predefined thermal conductivity coefficient for scales often found in reference objects such as reptiles may be stored in the object database 150 as 0.2 W/m-K.

At block 360, the electronic computing device 110 classifies the detected object under a particular one of the candidate object classifications included in the set when the changes in thermal characteristics captured corresponding to the object correlate with the changes expected in thermal characteristics of the material selected corresponding to the particular one of the candidate object classifications. As an example, when aluminum material is selected as the material for differentiating a reference object such as a drone classified under a first candidate object classification or unmanned aerial vehicles, the electronic computing device 110 classifies the detected object under a category of the first candidate object classification or unmanned aerial vehicles when the changes in thermal characteristics captured corresponding to the detected object indicate a thermal conductivity efficient that matches with or is substantially closer (e.g., 95%) to the predefined thermal conductivity coefficient (i.e., 237 W/m-K) associated with the aluminum material. In this example, when feather is selected as the material for differentiating a reference object such as a bird classified under a second candidate object classification or wildlife, the electronic computing device 110 may determine that the changes in thermal characteristics captured corresponding to the detected object indicate a thermal conductivity that does not match with or is not substantially closer (e.g., 95%) to the predefined thermal conductivity (i.e., 0.025 W/m-K) associated with the feather material. In other words, the electronic computing device 110 determines that the object detected at block 310 is materially similar to reference objects such as drones classified under unmanned aerial vehicles in comparison to reference objects such as birds classified under wildlife. Accordingly, the electronic computing device 110 classifies the detected object under a category of the unmanned aerial vehicles.

Optionally, the electronic computing device 110 may repeat the execution of the process 300 to determine a sub-classification under the broader unmanned aerial vehicles classification. For example, the broader unmanned aerial vehicles classification could be further divided into a first sub-classification with a reference object such as a war drone (e.g., a drone with weapon capability) defining the first sub-classification and a second sub-classification with a reference object such as a photo drone (e.g., drone without weapon capability and used only for imaging purposes) defining the second sub-classification. In this example, the electronic computing device 110 may determine that a photo drone may be differentiated from a war drone based on plastic material (or other unique material purposely introduced during construction of a given object to particularly differentiate the given object from other objects) which is predominantly associated with photo drones primarily used for imaging purposes. Accordingly, the electronic computing device 110 may repeat the process 300 to determine whether the detected object can be further classified under a particular one of the sub-classifications (e.g., photo drone) under the broader assigned classification (e.g., unmanned aerial vehicle) based on a material (e.g., plastic) specifically associated with reference objects used to define the particular one of the sub-classifications.

In accordance with some embodiments, after determining that detected object is classified under a particular one of the candidate object classifications, the electronic computing device 110 may store, for example, at the static memory 230, information indicating that the detected object is classified under the particular one of the candidate object classifications. As an example, when the electronic computing device 110 classifies a detected object under a category of unmanned aerial vehicles, the electronic computing device 110 further stores information indicating that a particular detected object has been classified under the category of unmanned aerial vehicles. The electronic computing device 110 may also optionally store information indicating sub-classifications for the object. The electronic computing device 110 may, in addition to the classification information, store information indicating a time at which the object was detected by the object detection device 120, position or location of the detected object, and changes in thermal characteristics observed corresponding to the object. Additionally or alternatively, the electronic computing device 110 sends a notification to one or more computing devices associated with one or more users (e.g., security operators) to provide information corresponding to the classification of a particular detected object. The electronic computing device 110 may provide the notification in the form of a visual and/or audio output via a visual and/or audio output device coupled to the electronic computing device 110. The visual and/or audio output may indicate, among other things, that the detected object is classified under a particular one of the candidate object classifications. In one embodiment, the electronic computing device 110 further determines whether the particular one of the candidate object classifications is associated with a category of objects that presents a security risk, for example, to persons or objects located in an area. In this embodiment, the object database 150 may be preconfigured with information indicating a security risk level for different known object classifications. In one example, the object database 150 may indicate that objects such as drones classified under unmanned aerial vehicles have a higher security risk than objects such as birds classified under wildlife. In this example, when the object detected at block 310 is classified under unmanned aerial vehicles, the electronic computing device 110 determines that there is a higher security risk associated with the detected object and in response provides a security alert to one or more computing devices associated with one or more users to indicate the security risk associated with the detected object.

In accordance with some embodiments, when the comparison performed at block 350 indicates that the changes in thermal characteristics captured corresponding to the object does not correlate with the changes expected in thermal characteristics of the material selected corresponding to any of the candidate object classifications included in the set, the electronic computing device 110 may store and/provide a notification indicating that the detected object cannot be classified. In one embodiment, before storing and/or providing a notification indicating that the detected object cannot be classified, the electronic computing device 110 may select, for each one of the one or more object classifications included in the set, a different material that differentiates the reference object used to define the candidate object classification from other reference objects used to define the other candidate object classifications included in the set. The electronic computing device 110 then repeats the functions described at block 350 and 360 to determine whether the object can be accurately classified under one of the candidate object classifications using the different material. In this case, the electronic computing device 110 compares the changes in thermal characteristics captured corresponding to the object with changes expected in thermal characteristics of the different material selected corresponding to one or more of the candidate object classifications included in the set. The electronic computing device 110 then classifies the detected object under the particular one of the one or more of the candidate object classifications included in the set when the changes in the thermal characteristics captured corresponding to the object correlate with the changes expected in thermal characteristics of the different material selected corresponding to the particular one of the one or more of the candidate object classifications. As an example, assume that the changes in thermal characteristics captured corresponding to a detected object does not correlate with expected changes in thermal characteristics corresponding to either an aluminum material selected corresponding to a reference object such as a drone classified under unmanned aerial vehicles or a feather material selected corresponding to a reference object such as a bird classified under wildlife. In this example, the electronic computing device 110 may attempt to classify the detected object again, for example, by selecting a different material such as a plastic that can differentiate a drone from a bird and/or by selecting a different material such as bones or tissues that can differentiate a bird from a drone. The electronic computing device 110 then compares the changes in thermal characteristics captured corresponding to the detected object with changes expected in thermal characteristics of the plastic material selected corresponding to a reference object such as the drone or bones or tissue material selected corresponding to a reference object such as the bird. When there is a correlation with the thermal characteristics corresponding to the plastic material, the electronic computing device 110 classifies the detected object under the classification of unmanned aerial vehicles. On the other hand, when there is a correlation with the thermal characteristics corresponding to the bone or tissue material, the electronic computing device 110 classifies the detected object under the wildlife classification. The electronic computing device 110 may repeat the process for selecting a different material and performing a comparison until either there is a correlation with thermal characteristics expected in the different material or all the materials identified for object differentiation have been analyzed without any correlation in the thermal characteristics.

The embodiments described herein can be advantageously implemented for accurate classification of objects in numerous applications across various industries. In retail and logistics, accurate object classification is essential for inventory management, product sorting, and supply chain optimization. In the realm of autonomous vehicles and robotics, classifying objects enables machines to navigate and interact safely with their environment by identifying obstacles, hazards, or points of interest. In security and surveillance, it aids in threat detection and monitoring by recognizing objects of concern. Moreover, in the medical field, classifying medical images and scans supports diagnostic processes by identifying anatomical structures and potential pathologies. Additionally, in the context of forest fire prevention, embodiments described herein can be implemented for identifying and differentiating between items that can contribute to the ignition of wildfires such as glass bottles, and those that are harmless, like stones.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate element or device via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for classifying an object, the method comprising:
detecting, at an electronic computing device, an object;
determining, at the electronic computing device, a set of candidate object classifications for the object;
selecting, at the electronic computing device, for each of the candidate object classifications included in the set, a material that differentiates a reference object used to define the candidate object classification from other reference objects used to define other candidate object classifications included in the set;
controlling, at the electronic computing device, an energy emitting device to emit a focused beam of energy in a direction toward the object, and responsively capturing changes in thermal characteristics corresponding to the object;
comparing, at the electronic computing device, the changes in thermal characteristics captured corresponding to the detected object with changes expected in thermal characteristics of the material selected corresponding to each of the candidate object classifications included in the set; and
classifying, at the electronic computing device, the detected object under a particular one of the candidate object classifications included in the set when the changes in the thermal characteristics captured corresponding to the object correlate with the changes expected in thermal characteristics of the material selected corresponding to the particular one of the candidate object classifications.

2. The method of claim 1, further comprising:
storing, at a memory coupled to the electronic computing device, information indicating that the detected object is classified under the particular one of the candidate object classifications.

3. The method of claim 1, further comprising:
providing, via a visual and/or audio output device coupled to the electronic computing device, a visual and/or audio output indicating that the detected object is classified under the particular one of the candidate object classifications.

4. The method of claim 1, further comprising:
determining that the particular one of the candidate object classifications is associated with a category of objects that presents a security risk; and
providing a security alert indicating the security risk associated with the detected object.

5. The method of claim 1, further comprising:
controlling an infrared spectrum camera to capture a sequence of images corresponding to an interaction between the focused beam of energy and the object; and
analyzing differences between the sequence of images to determine a thermal conductivity coefficient associated with a particular region of the object, wherein the particular region is identified as potentially containing the selected material.

6. The method of claim 5, wherein comparing comprises:
determining whether the thermal conductivity coefficient correlates with a predefined thermal conductivity coefficient associated with the selected material.

7. The method of claim 1, wherein the material is selected from a plurality of materials including a first material and second material forming part of the reference object used to define the candidate object classification, the method comprising:
determining that the first and second materials each differentiate the reference object used to define the candidate object classification from the other reference objects used to define the other candidate object classifications included in the set;
determining a level of energy required to capture observable changes in thermal characteristics of the first material; and
determining a level of energy required to capture observable changes in thermal characteristics of the second material.

8. The method of claim 7, wherein the selected material is the first material when the level of energy required to capture observable changes in thermal characteristics of the first material is lower than the level of energy required to capture observable changes in thermal characteristics of the second material.

9. The method of claim 7, wherein the selected material is the second material when the level of energy required to capture observable changes in thermal characteristics of the first material is higher than the energy required to capture observable changes in thermal characteristics of the second material.

10. The method of claim 1, further comprising:
determining that the comparison indicates that the changes in the thermal characteristics captured corresponding to the object do not correlate with the changes expected in thermal characteristics of the material selected corresponding to any of the candidate object classifications included in the set; and
providing, via a visual and/or audio output device coupled to the electronic computing device, a visual and/or audio output indicating that the detected object cannot be classified.

11. The method of claim 1, further comprising:
determining that the comparison indicates that the changes in the thermal characteristics captured corresponding to the object do not correlate with the changes expected in thermal characteristics of the material selected corresponding to any of the candidate object classifications included in the set; and
selecting, for each of the one or more candidate object classifications, a different material that differentiates the reference object used to define the candidate object classification from the other reference objects used to define the other candidate object classifications included in the set; and
comparing the changes in thermal characteristics captured corresponding to the detected object with changes expected in thermal characteristics of the different material selected corresponding to one or more of the candidate object classifications included in the set; and
classifying, at the electronic computing device, the detected object under the particular one of the one or more of the candidate object classifications included in the set when the changes in the thermal characteristics captured corresponding to the object correlate with the changes expected in thermal characteristics of the different material selected corresponding to the particular one of the one or more of the candidate object classifications.

12. The method of claim 1, wherein the focused beam of energy includes one of light, sound, or electromagnetic waves.

13. The method of claim 1, wherein controlling comprises:
identifying a part of the reference object in which the material selected corresponding to the candidate object classification is located;
identifying an area of the detected object that corresponds to the part of the reference object in which the material selected in located; and
controlling the energy emitting device to direct the focused beam of energy toward the identified area of the detected object.

14. The method of claim 1, wherein controlling comprises:
transmitting an electronic signal to the energy emitting device with an instruction to emit the focused beam of energy toward the detected object at a predetermined intensity and for a specified duration.

15. An electronic computing device, comprising:
a communications interface; and
an electronic processor communicatively coupled to the communications interface, the electronic processor configured to:
detect an object;
determine a set of candidate object classifications for the object;
select, for each of the candidate object classifications included in the set, a material that differentiates a reference object used to define the candidate object classification from other reference objects used to define other candidate object classifications included in the set;
control an energy emitting device to emit a focused beam of energy in a direction toward the object, and responsively capturing changes in thermal characteristics corresponding to the object;
compare the changes in thermal characteristics captured corresponding to the detected object with changes expected in thermal characteristics of the material selected corresponding to each of the the candidate object classifications included in the set; and
classify the detected object under a particular one of the candidate object classifications included in the set when the changes in the thermal characteristics captured corresponding to the object correlate with the changes expected in thermal characteristics of the material selected corresponding to the particular one of the candidate object classifications.

16. The electronic computing device of claim 15, further comprising:
a memory communicatively coupled to the electronic processor, wherein the electronic processor is configured to store, at the memory, information indicating that the detected object is classified under the particular one of the candidate object classifications.

17. The electronic computing device of claim 15, further comprising:
an electronic display or a speaker communicatively coupled to the electronic processor, wherein the electronic processor is configured to provide a notification, via the electronic display or the speaker, indicating that the detected object is classified under the particular one of the candidate object classifications.

18. The electronic computing device of claim 15, wherein the electronic processor is configured to:
determine that the particular one of the candidate object classifications is associated with a category of objects that presents a security risk; and
provide a security alert indicating the security risk associated with the detected object.

19. The electronic computing device of claim 15, wherein the electronic processor is configured to:
control an infrared spectrum camera to capture a sequence of images corresponding to an interaction between the focused beam of energy and the object; and
analyze differences between the sequence of images to determine a thermal conductivity coefficient associated with a particular region of the object, wherein the particular region is identified as potentially containing the selected material.

20. The electronic computing device of claim 19, wherein the electronic processor is configured to determine whether the thermal conductivity coefficient correlates with a predefined thermal conductivity coefficient associated with the selected material.
